(19) United States
(12) Patent Application Publication
(10) Pub. No.: US 2026/0177983 A1
(43) Pub. Date: Jun. 25, 2026

(54) WATCH AND METHOD FOR FASTENING THE WATCH DIAL

(71) Applicant: ETA SA MANUFACTURE HORLOGÈRE SUISSE, Grenchen (CH)

(72) Inventors: Gautier SCHNEIDER, Neuchåtel (CH); Christian Rufenacht, Bienne (CH)

(73) Assignee: ETA SA MANUFACTURE HORLOGÈRE SUISSE, Grenchen (CH)

(21) Appl. No.: 19/413,230

(22) Filed: Dec. 9, 2025

(30) Foreign Application Priority Data
Dec. 19, 2024 (EP) 24221448.4

(51) Int. Cl. G04B 19/14; G04B 19/18; G04B 37/22

(52) U.S. Cl. CPC G04B 19/14; G04B 19/18; G04B 37/22

(57) ABSTRACT

A watch including a middle (1), a bezel (2) and a dial (3), the bezel being attached to the middle by a fastener, a screw. The dial (3) is held along its periphery between the middle and the bezel. An axial damping element (4) made of flexible material is arranged and partially compressed between the dial (3) and the bezel (2). The damping element can take the form of an O-ring, installed between a peripheral stop (13) on the inner wall of the bezel (2) and a peripheral portion (15) of the front face of the dial. The axial damping element (4) reduces the effect of frontal shocks on the watch, thereby reducing the risk of cracks or other damage to the dial. The fact that the dial (3) is held between the bezel and the middle makes it possible to incorporate the dial fastener into the external part of the watch.

### CROSS REFERENCE TO RELATED APPLICATIONS

This application claims priority to European Patent Application No. No 24221448.4, filed on December 19, 2024, the entire contents of which are incorporated herein by reference.

### TECHNICAL FIELD

The invention relates to the field of horology. The invention relates in particular to means for fastening a watch dial.

### Technological background

In the horology industry, the dial is often fastened by bolts or keys that attach the dial to the plate on the watch movement. The rigidity of fastening systems of this type makes the dial sensitive to deterioration caused by shocks. Almost all of the energy, especially from frontal shocks, is transmitted to the dial, which can crack.

It would therefore be desirable to have a solution that better protects the dial from shocks to the watch.

### SUMMARY OF THE INVENTION

The invention aims to provide a solution to the problems described above. This objective is achieved by a watch and by the assembly methods according to the claims appended hereto.

A watch according to the invention comprises a middle, a bezel and a dial, the bezel being attached to the middle by fastening means, for example by screwing. The dial is held along its periphery between the middle and the bezel. Moreover, an axial damping element made of flexible material is arranged and partially compressed between the dial and the bezel. The damping element can take the form of an O-ring, installed between a peripheral stop on the inner wall of the bezel and a peripheral portion of the front face of the dial. The axial damping element reduces the effect of frontal shocks on the watch, thereby reducing the risk of cracks or other damage to the dial. The fact that the dial is held between the bezel and the middle makes it possible to incorporate the dial fastener into the external part of the watch.

According to specific embodiments, the watch also comprises lateral damping elements to protect the dial from lateral shocks to the watch.

### BRIEF DESCRIPTION OF THE FIGURES

The invention will be described in greater detail below with reference to the appended drawings, which are given by way of non-limiting examples, in which:

FIG. 1 is an exploded view of a number of components of a watch according to one embodiment of the invention,

FIG. 2 is a cross-sectional view of the components in FIG. 1 after they have been assembled,

FIG. 3 is a close-up of the cross-sectional view in FIG. 2, to illustrate the position of the axial damping element,

FIGS. 4a and 4b are views from the underside of the dial and bezel assembly according to one embodiment of the invention, comprising auxiliary elements for orienting the dial relative to the bezel,

FIG. 5 is a close-up view of an embodiment comprising lateral damping elements.

### DETAILED DESCRIPTION OF THE INVENTION

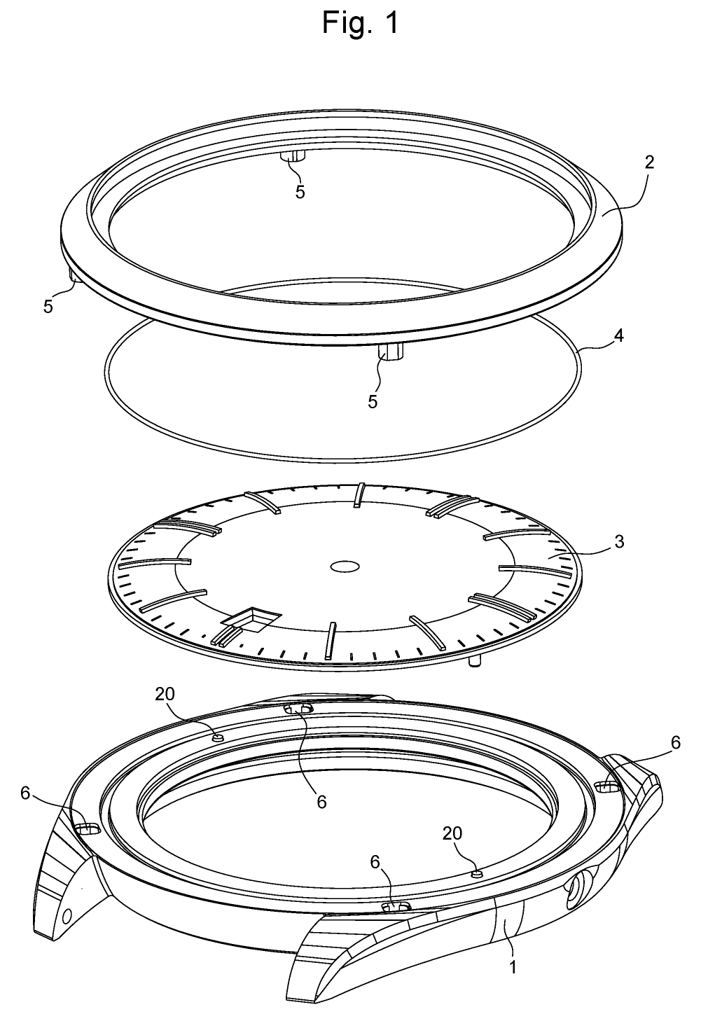

FIG. 1 shows the components that contribute to the characteristic aspects of one embodiment of the invention, in particular the watch middle 1, the bezel 2 and the dial 3, as well as the axial damping element 4 arranged between the bezel and the dial.

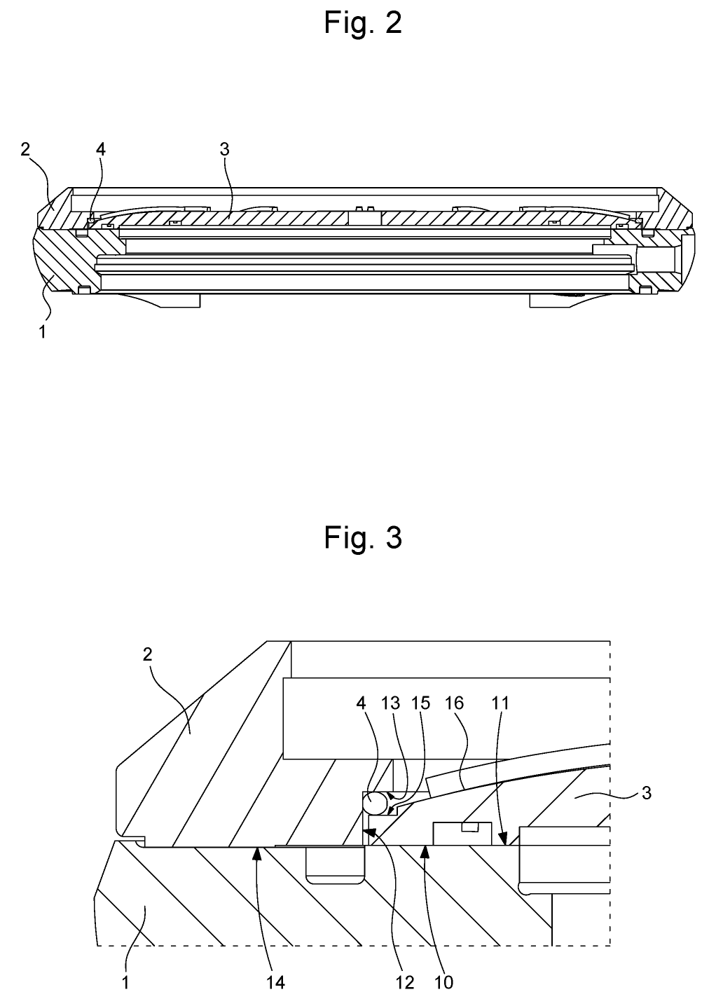

FIG. 2 shows a cross-sectional view of the assembly produced by assembling components 1 to 4. As can be seen in FIG. 1, the bezel 2 comprises feet 5 on its rear face. These feet 5 are arranged in corresponding holes 6 through the middle 1. For example, the feet 5 have threaded holes through which the bezel 2 can be screwed against the front face of the middle 1.

FIG. 2 and the close-up view in FIG. 3 demonstrate that the dial 3 is held along its periphery between the middle 1 and the bezel 2. In the form shown, the dial 3 comprises a flat rear face 10 that abuts the front face 11 of the middle 1. The inner wall 12 of the bezel 2 is fitted with a peripheral stop 13 that can be seen and reached (when viewing the bezel without the other components) from the rear face 14 of the bezel 2. The axial damping element takes the form of an O-ring 4 arranged between the stop 13 on the bezel 2 and a peripheral portion 15 of the front face of the dial 3. According to the embodiment shown, the peripheral portion 15 takes the form of a narrow zone that is parallel to the rear face 10 of the dial, while the remainder 16 of the front face of the dial is slightly concave. However, the dial section can be formed into other shapes, provided that these shapes enable a damping element to be introduced between the dial and the bezel.

The dimensions of the components described are designed such that the axial damping element 4 is partially compressed between the bezel 2 and the dial 3 when the bezel 2 is fastened to the middle 1. Partial compression is defined as compression that keeps the damping element in a flexible state that allows frontal shocks to be absorbed while keeping the dial on the middle. The degree of compression depends on the dimensions of the components and on the choice of material for the damping element. One example of a material that can be used in the invention is Hytrel®7246 from the manufacturer Celanese.

The resilience of the damping element 4 reduces the risk of the dial cracking as a result of frontal shocks to the watch.

According to embodiments of the invention, auxiliary elements are provided for orienting the dial. In the embodiment shown in FIG. 1, these elements comprise two pins 20 fastened to the front face of the middle 1 and two blind holes (not visible in FIG. 1) on the rear face of the dial 3, configured to hold the pins 20 in the respective holes. Preferably, one of the blind holes is circular (cross-sectional view), and configured to hold one of the pins with essentially no clearance between the pin and the inner wall of the hole, while the other hole is oblong. This configuration allows the orientation of the dial to be adjusted slightly and ensures that the dial is fastened without introducing stresses that could damage the dial.

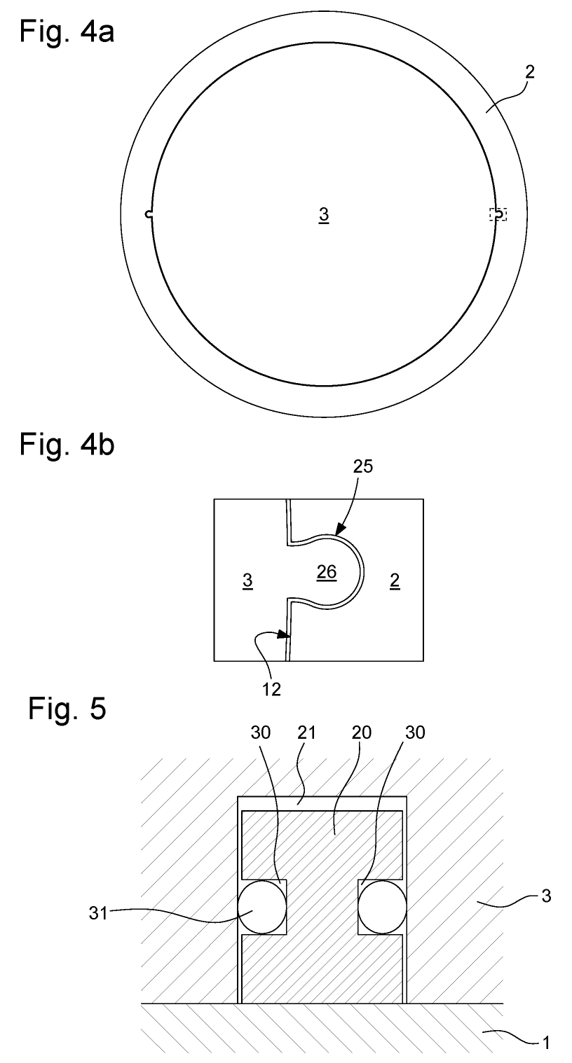

Other auxiliary elements for orienting the dial are possible without departing from the scope of the invention. For example, instead of orienting the dial relative to the middle, auxiliary elements can be provided to orient the dial relative to the bezel. This could be achieved as shown in FIGS. 4a and 4b. Two radial notches 25 are machined in the inner wall 12 of the bezel 2. The dial 3 is fitted with radial pins 26 fastened to or made in one piece with the dial, which fit into the notches 25 to achieve the correct orientation.

Preferably there are two auxiliary elements for orienting the dial, for example two axial pins 20 or two radial pins 26, but it is not beyond the scope of the invention to have more than two auxiliary elements for orienting the dial.

Components 1 to 4 can be assembled to form the assembly shown in FIG. 2 by carrying out the following steps:

place the middle 1 on a support surface, preferably horizontal, The watch movement (not shown in the figures) can already be fitted in the middle in this step,

then place the dial 3 on the middle and orient the dial relative to the middle. According to the embodiment illustrated in FIG. 1, the correct orientation is achieved by placing the dial 3 such that the pins 20 fit into the blind holes provided on the rear face of the dial,

then place the bezel 2 on the dial 3, with the axial damping element arranged between them. For example, in the embodiment shown in FIGS. 1 to 3, the O-ring 4 can be placed in contact with the stop 13 on the bezel. Preferably, the outer diameter of the ring 4 is chosen to be slightly greater than the diameter of the inner wall 12 of the bezel. This enables the bezel to be handled with the ring installed on it, and the bezel and ring assembly to be placed on dial 3,

then, fasten the bezel 2 to the middle 1 using the feet 5 and holes 6, thereby partially compressing the damping element 4 and keeping the dial 3 in place.

If auxiliary elements are applied to orient the dial relative to the bezel, such as the pins 26 and radial notches 25 shown in FIGS. 4a and 4b, the bezel and dial must first be assembled using these auxiliary elements 25, 26 for orienting the dial and with the damping element installed between the dial and the bezel, and then this assembly must be placed on the middle, so that the bezel can be fastened to said middle.

Attaching the dial and fitting and fastening the bezel are among the operations involved in adding the external parts to the watch. Since the dial is held between the bezel and the middle by the axial damping element, fastening the dial is also included when adding the external parts. However, this fastening requires less handling and fewer components than conventional dial fastening systems using keys or bolts.

According to some embodiments, lateral damping is provided in addition to axial damping. One non-limiting way of implementing these embodiments is illustrated in FIG. 5, which shows a cross-sectional view of one of the orientation pins 20 fastened to the middle 1 and inserted into one of the blind holes 21 in the dial 3. A peripheral groove 30 is provided in the lateral wall of the pin 20 and an O-ring 31 made of flexible material is fitted into the groove 30. The dimensions of the components shown and of the hole 21 are designed so that the O-ring 31 is partially compressed between the back of the groove 30 and the wall of the blind hole 21. This arrangement, applied to each of the orientation pins 20, makes it possible to dampen the effect of lateral shocks to the watch.

In the embodiment shown in FIG. 5, applying two blind holes 21 and two orientation pins 20, the two blind holes 21 are preferably circular (cross-sectional view). The lateral damping elements 31 will automatically centre the pins 20 in the holes 21 without any risk of stress.

1. A watch comprising a watch middle, a bezel attached to the middle and a dial, the bezel, dial and middle having a front face and a rear face, wherein:
the dial is held along its periphery between the middle and the bezel,
an axial damping element made of flexible material is arranged between the dial and the bezel, the damping element being partially compressed between the dial and the bezel.

2. The watch according to claim 1, wherein the axial damping element is an O-ring arranged along the periphery of the dial.

3. The watch according to claim 1, wherein the bezel is screwed to the middle.

4. The watch according to claim 1, wherein:
the bezel comprises an inner wall fitted with a peripheral stop,
the axial damping element is held and partially compressed between said stop and a peripheral portion of the front face of the dial.

5. The watch according to claim 1, further comprising auxiliary elements for orienting the dial relative to the middle or relative to the bezel.

6. The watch according to claim 5, comprising auxiliary elements for orienting the dial relative to the middle, said auxiliary elements comprising at least two pins fastened to the front face of the middle, the pins being inserted in respective blind holes provided in the rear face (10) of the dial.

7. The watch according to claim 5, further comprising auxiliary elements for orienting the dial relative to the bezel, said auxiliary elements comprising at least two radial pins fastened to or made in one piece with the dial and notches in the inner wall of the bezel, the radial pins being inserted in the respective notches.

8. The watch according to claim 1, further comprising one or more lateral damping elements arranged between the middle and the dial.

9. The watch according to claim 8, wherein:
the middle is fitted with at least two orientation pins fastened to the front face of the middle, the orientation pins being inserted into respective blind holes provided in the rear face of the dial,
each of the orientation pins is provided with a peripheral groove,
a lateral damping element is arranged in each of the grooves, the lateral damping element being partially compressed between the back of the groove and the inner wall of the blind holes.

10. The watch according to claim 9, wherein the blind holes have a circular cross-section in a plane perpendicular to the orientation pins.

11. A method for assembling the middle, bezel and dial of a watch according to claim 6, the method comprising the following steps:
place the middle on a support surface, preferably horizontal,
then place the dial on the middle and orient the dial relative to the middle by inserting the pins on the front face of the middle into the blind holes in the rear face of the dial,
then place the bezel on the dial, with the axial damping element arranged between them,
then fasten the bezel to the middle, thereby partially compressing the damping element.

12. The method for assembling the middle, bezel and dial of a watch according to claim 7, the method further comprising the following steps:
place the middle on a support surface, preferably horizontal,
orient the dial relative to the bezel, with the axial damping element arranged between them, by inserting the radial pins on the dial into the notches in the bezel,
then place the bezel and dial assembly on the middle,
then fasten the bezel to the middle, thereby partially compressing the damping element.
